(19) United States
(12) Patent Application Publication
(10) Pub. No.: US 2016/0148512 A1
(43) Pub. Date: May 26, 2016

(54) SYSTEM AND METHOD FOR TRAFFIC INCIDENT REPORTING

(71) Applicant: QATAR UNIVERSITY QSTP-B, Doha (QA)

(72) Inventors: Hamid MENOUAR, Doha (QA); Wassim DRIRA, Doha (QA); Fethi FILALI, Doha (QA); Adnan ABU-DAYYA, Doha (QA)

(73) Assignee: QATAR UNIVERSITY QSTP-B, Doha (QA)

(21) Appl. No.: 14/900,158

(22) PCT Filed: Jun. 21, 2013
(86) PCT No.: PCT/IB2013/055113

§ 371 Date: Dec. 20, 2015

(51) Int. Cl. G08G 1/16; H04W 4/02; H04W 24/08

(52) U.S. Cl. CPC G08G 1/163; H04W 24/08; H04W 4/023

(57) ABSTRACT

Disclosed is a system for traffic incident reporting comprising the present invention provides a system for traffic incident reporting comprising: a plurality of vehicles and infrastructure units employing a vehicle to vehicle and vehicle to infrastructure communication technology capable of sharing real time and historical information of one or more vehicles involved in the traffic incident and other vehicles in a predefined area of the traffic incident.

### FIELD OF THE INVENTION

The present invention generally relates to systems and methods for reporting of traffic accidents and other incidents, and, specifically to traffic incident reporting systems and method employing vehicle to vehicle and vehicle to infrastructure communication technologies, such as, the V2X technology.

### BACKGROUND OF THE INVENTION

A traffic collision, also known as a traffic accident, occurs when a vehicle collides with another vehicle, pedestrian, animal, road debris, or other stationary obstruction, such as a tree or utility pole. Traffic collisions may result in injury, death, vehicle damage, and property damage. Generally all such aspects are covered by insurance these days. Accordingly, it is of utmost importance to determine the nature and reason for the traffic accident, based on which a fair and accurate analysis can be made of the insurance to be claimed and applicable laws to be enforced.

A number of factors contribute to the risk of collision, including vehicle location (latitude, longitude, and the heading direction), speed of vehicle, exterior light status, behavior and skill of driver, behavior of co-passengers, road design, and road environment. Generally, it is challenging to determine some of these factors at the time the traffic accident took place.

Usually, when a traffic accident or any other incident of traffic violation occurs, an accident report is issued either by the involved drivers and/or by specific authorities (such as police personnel), and such a report is referred to as an incident report. The incident report requires an analysis on which of the collision/accident units (i.e., the vehicles) are at fault and the reasons for this fault (for example, driver or co-passenger behavior). It is a challenging job to get the accurate details as the involved parties (drivers and/or co-passengers) are biased in their analysis when describing the incident. Also, since the authorities are not always present at the accident/incident site, it is very difficult for them to exactly determine the accident parameters. In some cases, the use of witnesses is solicited; in some other cases photos and/or videos of the accident/incident scene are analyzed; and also police investigations are carried out. Such a manual solution of making an incident report is limited in its assessment accuracy, while the fairness is also questionable.

Another solution involves using sensors on the road (or in the vehicle) to monitor a driver's behavior such as over-speeding and signal violations, and then generating incident reports based on such monitoring that can be accessed by the involved parties and the authorities. Such a solution is usually very expensive and has a low penetration. Additionally, these sensors are not able to collect and merge data gathered from other vehicles that were directly or indirectly involved in the specific area the incident took place.

For insurance-related use-cases, some insurance companies provide their clients with a logger device which records location (geographical position and driving speed and heading) of the insured vehicle. This is similar to a black box in an aircraft. The recorded information can be used to assess if the insured car (i.e. driver) has done any mistakes making it the faulty part in the accident. Such solution is limited to the equipped vehicle as it does not record anything about vehicles in the surrounding area.

Accordingly, there is a need for a system and a method that provides a fair, accurate, and cost efficient reporting a traffic incident.

### SUMMARY OF THE INVENTION

In view of the foregoing disadvantages inherent in the prior-art, the general purpose of the present invention is to provide a system and method for traffic incident reporting that is configured to include all advantages of the prior art and to overcome the drawbacks inherent in the prior art offering some added advantages.

In one aspect, the present invention provides a system for traffic incident reporting comprising: a plurality of mobile communication units operably communicating with each other over a wireless network. Each of the plurality of mobile communication units comprises: a sensor; a mobile interface module in operative communication with the sensor and other mobile communication units; a mobile processing module in operative communication with the sensor and the mobile interface module; a memory in operative communication with the mobile processing module; and a mobile user interaction module in operative communication with the mobile processing unit. The sensor is capable of gathering data of an associated vehicle. The mobile interface module is capable of: receiving data of the associated vehicle from the sensor; transmitting data of the associated vehicle to other mobile communication units; and receiving data of other associated vehicles from other mobile communication units. The mobile processing module is capable of processing and analyzing data of associated vehicles in a pre-defined area to generate a traffic incident report. The memory is capable of storing the processed data of associated vehicles and the traffic incident report. The user interaction module s capable of providing the traffic incident report to a user.

In another aspect, the present invention provides a system for traffic incident reporting comprising: a plurality of mobile communication units, a plurality of fixed communication units and a central unit operably communicating with each other over a wireless network. Each of the plurality of mobile communication units is capable of: gathering data of an associated vehicle; transmitting data of the associated vehicle to other mobile communication units, the plurality of fixed communication units and the central unit; and receiving data of other associated vehicles from other mobile communication units. Each of the fixed communication unit is capable of: receiving data of associated vehicles from the plurality of mobile communication units and other fixed communication units; and transmitting data of associated vehicles to the plurality of mobile communication units, other fixed communication units, and the central unit. The central unit is capable of: receiving data of associated vehicles from the plurality of mobile communication units and the plurality of fixed communication units; processing and analyzing the received data of associated vehicles in a pre-defined area to generate a traffic incident report; storing data of the associated vehicles and the traffic incident report; and providing the traffic incident report to a user.

In another aspect, the present invention provides a method for traffic incident reporting comprising: configuring a plurality of mobile communication units operably communicating with each other over a wireless network; gathering data on one or more associated vehicles; transmitting and receiving data on the associated vehicles between the mobile communication units; processing and analyzing data on the associated vehicles in a pre-defined area to generate a traffic incident report; storing the processed data on associated vehicles and the traffic incident report; and providing the traffic incident report to a user.

In another aspect, the present invention provides a method for traffic incident reporting comprising: configuring a plurality of mobile communication units, a plurality of fixed communication units and a central unit operably communicating with each other over at least one of a wireless network and a wired network; gathering data on associated vehicles by the mobile communication units; transmitting and receiving data on the associated vehicles between the mobile communication units and the fixed communication units; transmitting data on associated vehicles to the central unit; processing and analyzing the received data on associated vehicles of the mobile communication units in a pre-defined area to generate a traffic incident report by the central unit; storing data of the associated vehicles and the traffic incident report by the central unit; and providing the traffic incident report to a user by the central unit.

In another aspect, the present invention provides a system for traffic incident reporting comprising: a plurality of vehicles and infrastructure units employing a vehicle to vehicle and vehicle to infrastructure communication technology capable of sharing real time and historical information of one or more vehicles involved in the traffic incident and other vehicles in a predefined area of the traffic incident.

In another aspect, the present invention provides a system for traffic law violation detection and reporting comprising: a plurality of vehicles and infrastructure units employing a vehicle to vehicle and vehicle to infrastructure communication technology capable of sharing real time and historical information of one or more vehicles involved in the traffic law violation and other vehicles in a predefined area of the traffic law violation.

These together with other aspects of the invention, along with the various features of novelty that characterize the invention, are pointed out with particularity in the claims annexed hereto and forming a part of this disclosure. For a better understanding of the invention, its operating advantages and the specific objects attained by its uses, reference should be had to the accompanying drawings and descriptive matter in which there are illustrated exemplary embodiments of the invention.

### BRIEF DESCRIPTION OF THE DRAWINGS

While the specification concludes with claims that particularly point out and distinctly claim the invention, it is believed that the advantages and features of the present invention will become better understood with reference to the following more detailed description of expressly disclosed exemplary embodiments taken in conjunction with the accompanying drawings. The drawings and detailed description which follow are intended to be merely illustrative of the expressly disclosed exemplary embodiments and are not intended to limit the scope of the present invention as set forth in the appended claims. In the drawings:

FIG. 1 illustrates a system for traffic incident reporting, according to an exemplary embodiment of the present invention;

FIG. 2 illustrates a mobile communication unit of the system of FIG. 1;

FIG. 3 illustrates a fixed communication unit of the system of FIG. 1;

FIG. 4 illustrates a system for traffic incident reporting, according to another exemplary embodiment of the present invention;

FIG. 5 illustrates a central unit of the system of FIG. 4;

FIG. 6 depicts a flow diagram of a method for traffic incident reporting, according to an exemplary embodiment of the present invention;

FIG. 7 depicts a flow diagram of a method for traffic incident reporting, according to another exemplary embodiment of the present invention;

FIG. 8 illustrates a traffic environment implementing V2X technology;

FIG. 9 illustrates an incident occurring in a traffic environment; and

FIG. 10 illustrates a non-limiting example of utilization of recorded information when an incident occurs.

Like reference numerals refer to like parts throughout the several views of the drawings.

### DETAILED DESCRIPTION OF THE INVENTION

The exemplary embodiments described herein detail for illustrative purposes are subject to many variations in structure and design. It should be emphasized, however, that the present invention is not limited to a particular system and method for traffic incident reporting, as shown and described. It is understood that various omissions and substitutions of equivalents are contemplated as circumstances may suggest or render expedient, but these are intended to cover the application or implementation without departing from the spirit or scope of the claims of the present disclosure. Also, it is to be understood that the phraseology and terminology used herein is for the purpose of description and should not be regarded as limiting.

The use of terms ‘including’, ‘comprising’ having' and variations thereof herein are meant to encompass the items listed thereafter and equivalents thereof as well as additional items. Further, the terms, ‘a’ and ‘an’ herein do not denote a limitation of quantity, but rather denote the presence of at least one of the referenced item.

The present invention provides systems and methods for traffic incident reporting. A traffic incident report generated from the present invention can serve to accurately determine vehicle insurance parameters and enforce traffic laws. As used herein, a ‘traffic incident’ refers to a traffic accident, a traffic law violation or any other incident through which behaviour of a driver and/or a co-passenger malfunctioning in the involved vehicles can be identified. Also, as used herein, a ‘traffic incident report’ refers to a report of a traffic incident generated by the system and method of the present invention. Such a report has a fair and accurate analysis of the traffic incident that has taken place.

Specifically, the present invention provides a system for traffic incident reporting comprising: a plurality of vehicles and infrastructure units employing a vehicle to vehicle and vehicle to infrastructure communication technology capable of sharing real time and historical information of one or more vehicles involved in the traffic incident and other vehicles in a predefined area of the traffic incident. Also, the present invention provides a system for traffic law violation detection and reporting comprising: a plurality of vehicles and infrastructure units employing a vehicle to vehicle and vehicle to infrastructure communication technology capable of sharing real time and historical information of one or more vehicles involved in the traffic law violation and other vehicles in a predefined area of the traffic law violation.

The system and method of the present invention employs vehicle to vehicle and vehicle to infrastructure communication technologies, such as, the V2X technology. Broadly, a vehicle (referred to as ‘mobile communication unit’ later in this description) or an infrastructure unit/ road side unit (abbreviated as RSU and referred to as fixed communication unit later in this description) equipped with a technology such as the V2X technology. This makes the vehicle and/or the RSU aware of its surroundings and the vehicle and/or the RSU can be in constant communication with other vehicles and/or the RSUs in its surroundings to share useful data. Accordingly, when driving on the road a vehicle records its own information and the information of other vehicles in the surrounding that have been received through a communication channel. Also, a RSU records information of vehicles passing in the surrounding that have been received through a communication channel.

Specifically, in a V2X environment, each vehicle is transmitting useful data about its location, speed and movement, status of exterior lights of the vehicle, type and size of vehicles, and driver and/or passenger behaviour from built-in communication units having sensors; and every other vehicle in this V2X environment is capable of receiving such useful data. Such useful data or information is hereinafter referred to as ‘data of an associated vehicle’, i.e., data of a vehicle in which a communication unit (having sensor) is installed or the information of the vehicle/station to which a communication unit is attached. Although, V2X technology is described herein; it will be evident to a person skilled in the art to employ any other similar technology for implementing the system and method of the present invention.

Such data of an associated vehicle includes, but is not limited to, a location data of the vehicle, a speed data of the vehicle, a lighting data of the vehicle, a type and size data of the vehicle, driver data of the vehicle, and a passenger data of the vehicle. Specifically, the location data of the vehicle comprises an estimate of the latitudinal position, longitudinal position, heading direction of the vehicle, and similar information that may assist in determining the a substantially accurate location of the vehicle. Location data is useful in analyzing as to involvement of the vehicle in the incident in terms of the vehicle's location relative to other instruments in the environment. The sensor of the communication unit may employ a global positioning system (GPS) module for calculating the location essential parameters of the vehicle, such as the latitudinal position and the longitudinal position. Other parameters that are calculated by the sensor for further assisting in determining the location include, but are not limited to, heading direction of the vehicle, and altitude. Athough, the system employs a GPS module herein; it will be evident to a person skilled in the art to employ other geo-localization systems and techniques.

Speed data of the vehicle includes data on instant speed of the vehicle at the time of incident, average speed of the vehicle, and similar information that assist in determining the speed of the vehicle. Speed data is useful to determine whether speed of the vehicle was one of the reasons for the incident. For example, over speeding is usually a primary reason for traffic accidents and traffic rule violations.

As used herein, the ‘lighting data of the vehicle’ includes status of all the exterior lights of the vehicle and status of any interior light that may be responsible for the incident. For example, information on whether the exterior lights were functioning; and if functioning whether they were function with the appropriate intensity. For interior lights, sometimes, when an interior light is malfunctioning or inappropriately powered on, it may distract the driver. Also, as used herein, the ‘type and size data of the vehicle’ includes details on the make and type of the vehicle and the different dimensions of the vehicle.

Driver data of the vehicle includes details on the behaviour, physical condition, and other demeanour aspects of the driver that would be responsible for the incident. Passenger data of the vehicle includes details on the number of passengers; and behaviour, physical condition, and other demeanour aspects of the passengers that would be responsible for the incident.

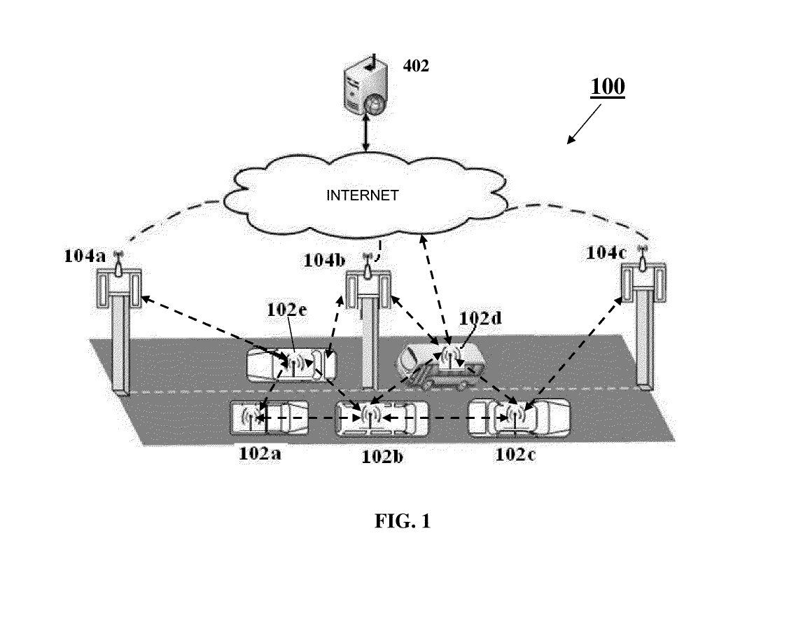

Referring to FIG. 1, in one embodiment, illustrated is a system 100 for traffic incident reporting. The system 100 comprises a plurality of mobile communication units 102a, 102b, 102c, 102d, 102e (hereinafter individually and collectively referred to as the mobile communication units 102). The mobile communication units 102 are operably communicating with each other over a wireless network. Examples of wireless networks may include cellular networks, radio frequency communication, wireless LANs, Zigbee networks, dial-on modems, and the like.

In one embodiment, the mobile communication unit 102 is a communication unit installed in an associated vehicle, or, an associated vehicle is manufactured with an inbuilt communication unit. In this embodiment, in the older vehicles that are not equipped with V2X or similar technologies, the mobile communication unit 102 functions a standalone device integrated in these older vehicles. In another embodiment, the mobile communication unit 102 is a communication unit installed in a personal communication device of a user. Such a user could be either the driver, or a passenger travelling in the associated vehicle, or any pedestrian (preferably in proximity to the site of the incident). The system 100 may comprise a combination of such different embodiments of the mobile communication units 102.

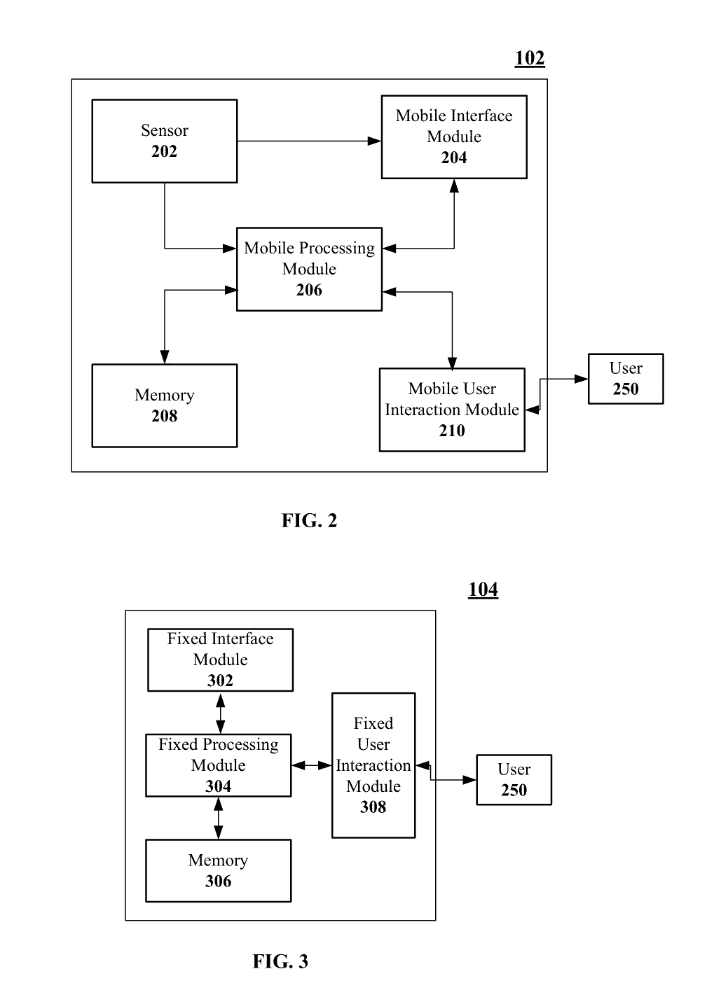

Referring to FIG. 2, the mobile communication unit 102 comprises a sensor 202. The sensor 202 is capable of gathering data of the associated vehicle. Specifically, the sensor is capable of sensing a location data of the vehicle, a speed data of the vehicle, a lighting data of the vehicle, driver data of the vehicle, a passenger data of the vehicle, and other data assisting in providing accurate incident report. As per the specific requirements, the sensor 202 may be a combination of a plurality of sensors including, but not limited to, a motion sensor, a vibration sensor, an impact sensor, a pollution sensor, a temperature sensor, a humidity sensor, an imaging device, and a light sensor. For example, as explained above, for sensing location data of the vehicle, the sensor 202 employs a GPS module for calculating the location parameters of the vehicle, including but not limited to, latitudinal position, longitudinal position, heading direction of the vehicle, and altitude.

The mobile communication unit 102 further comprises a mobile interface module 204 in operative communication with the sensor 202 and other mobile communication units 102. The mobile interface module 204 is capable of: transmitting data wirelessly of the associated vehicle to other mobile communication units 102; and receiving data wirelessly from other mobile communication units 102 of other associated vehicles. Employing V2X technology (discussed above) and other similar technologies, the mobile communication units 102 (and broadly the vehicle user of the associated vehicle) is capable of sending and receiving data from mobile communication units 102 of other vehicles in the surrounding area. The range of data (i.e., the number of vehicles in the network) that can be transmitted or received can be varied by the wireless communication range capabilities and connectivity of the other mobile communication units 102. The variation may be few meters or kilometres around the incident location; or may be as large a city or a country. The mobile interface module 204 includes a transceiver (a transmitter and receiver combination device) capable of wirelessly transmitting data on associated vehicle to other units; and capable of wirelessly receiving data on other associated vehicles.

The mobile communication unit 102 further comprises a mobile processing module 206 in operative communication with the sensor 202 and the mobile interface module 204. The mobile processing module 206 receives data on the associated vehicle from the sensor 202 to integrate the different forms of data (for example, vehicle location and speed and driver behaviour) to form one or more messages. Further, the mobile processing module 206 receives data from the mobile interface module 204 on other vehicles and processes data to understand the location, speed and driver behaviour of other vehicles. Overall, the mobile processing module 206 is capable of processing and analyzing data of the associated vehicles in a pre-defined area to generate a traffic incident report. The mobile processing unit 206 may be in form of a single hardware component. Alternatively, the mobile processing unit 206 may be a combination of multiple software, firmware and hardware components. The mobile processing module 206 has appropriate software such that the mobile processing module 206 can interpret and process V2X and other similar technologies.

The mobile communication unit 102 further comprises a memory 208 in operative communication with the mobile processing module 206. The memory 208 is capable of storing the processed data on associated vehicles and the traffic incident report. The memory 208 may be in form of a random access memory or other type of dynamic storage device, sufficient to hold the necessary programming and data structures located on the mobile communication unit 102. Alternatively, the memory 208 may take the form of a memory card, memory stick, compact flash, and the like.

The mobile communication unit 102 further comprises a mobile user interaction module 210 in operative communication with the mobile processing module 206. The mobile user interaction module 210 is capable of providing traffic incident report to a user 250. The traffic incident report comprises an analysis of the vehicle situation and driver/passenger situation to identify the faulty parties in the traffic incident along with still and video visuals of last moments of the incident. The traffic incident report may be accessed by the user 250 at the site of the mobile communication unit 102. In this case, the mobile user interaction module 210 may be in form of a unit having a Bluetooth interface, USB interface and the like. Alternatively, the mobile user interaction module 210 wirelessly transmits the traffic incident report to a personal communication device of the user 250. The personal communication device may be a mobile communication device (for example, cell phones, tablets, laptops and the like) or a desktop of the user 250.

Based on this traffic incident report, the user 250 manually can initiate appropriate action. Alternatively, the mobile user interaction module 210 automatically initiates the appropriate action (for example, triggering a fine, informing the appropriate parties and authority personnel, and the like). Also, the mobile user interaction module 210 provides user interface features to the user 250, wherein the user 250 may customize the report for a particular incident. Additionally, the user can extract further detailed information by requesting the mobile processing module 206 through the mobile user interaction module 210. As used herein, the user 250 may be a user of the vehicle involved in the incident (hereinafter termed as a ‘vehicle user’) or authority personnel or any other person at the site of incident.

The mobile communication unit 102 may further comprise the usual components, such as, a power unit for supplying power to the mobile communication unit 102. Alternatively, the mobile communication unit 102 may get power supply from the vehicle or the personal communication unit on which it is installed. Optionally, the mobile communication unit 102 may comprise a power ON/OFF switch for switching ON/OFF the mobile communication unit 102.

Referring to FIG. 1 again, the system 100 further comprises a plurality of fixed communication nodes 104a, 104b, 104c (hereinafter individually and collectively referred to as the fixed communication units 104). The fixed communication units 104 are in operable communication with the plurality of mobile communication units 102 and the other fixed communication units 104 over the wireless network. Alternatively, or in addition, the fixed communication units may also communicate with each other over a wired network.

Referring to FIG. 3, the fixed communication unit 104 comprises a fixed interface module 302. The fixed interface module 302 is capable of: receiving data on associated vehicles of the mobile communication units 102; and transmitting data on associated vehicles to other fixed communication units 104 and the mobile communication units 102. Employing V2X technology (discussed above) and other similar technologies, the fixed communication units 104 is capable of sending and receiving data from mobile communication units 102 and other fixed communication units 104. The range of data (i.e., the number of vehicles in the network) that can be transmitted or received can be varied by the wireless communication range capabilities and connectivity of the other fixed communication units 104 and other mobile communication units 102. The variation may be few meters or kilometres around the incident location; or may be as large a city or a country. The fixed interface module 302 includes a transceiver (a transmitter and receiver combination device) capable of wirelessly receiving data on other associated vehicles, and capable of wirelessly transmitting data on associated vehicle to other units.

The fixed communication unit 104 further comprises a fixed processing module 304 in operative communication with the fixed interface module 302. The fixed processing module 304 receives data on associated vehicle from the fixed interface module 302 and processes data to understand the location, speed, driver behaviour and other relevant characteristics of vehicles. Overall, the fixed processing module 304 is capable of processing and analyzing the received data on the associated vehicles of the mobile communication units 102 to generate the traffic incident report. The fixed processing module 304 may be in form of a single hardware component. Alternatively, the fixed processing module 304 may be a combination of multiple software, firmware and hardware components. The fixed processing module 304 has appropriate software such that the fixed processing module 304 can interpret and process V2X and other similar technologies.

The fixed communication unit 304 further comprises a memory 306 in operative communication with the mobile processing module 206. The memory 306 is capable of storing the received data of the associated vehicles, and the traffic incident report. The memory 306 may be in form of a random access memory or other type of dynamic storage device, sufficient to hold the necessary programming and data structures located on the fixed communication unit 104. Alternatively, the memory 306 may take the form of a memory card, memory stick, compact flash, and the like.

The fixed communication unit 104 further comprises a fixed user interaction module 308 in operative communication with the fixed processing module 306. The fixed user interaction module 308 is capable of providing traffic incident report to the user 250. The traffic incident report may be accessed by the user 250 at the site of the fixed communication unit 104. In this case, the mobile user interaction module 308 may be in form of a unit having a Bluetooth interface, USB interface and the like. Alternatively, the fixed user interaction module 308 remotely transmits the traffic incident report to a personal communication device of the user 250. The personal communication device may be a mobile communication device (for example, cell phones, tablets, laptops and the like) or a desktop of the user 250.

The fixed communication unit 104 may further comprise the usual components, such as, a power unit for supplying power to the fixed communication unit 104. Alternatively, the fixed communication unit 104 may get power supply from the vehicle or the personal communication unit on which it is installed. Optionally, the fixed communication unit 104 may comprises a power ON/OFF switch for switching ON/OFF the fixed communication unit 104.

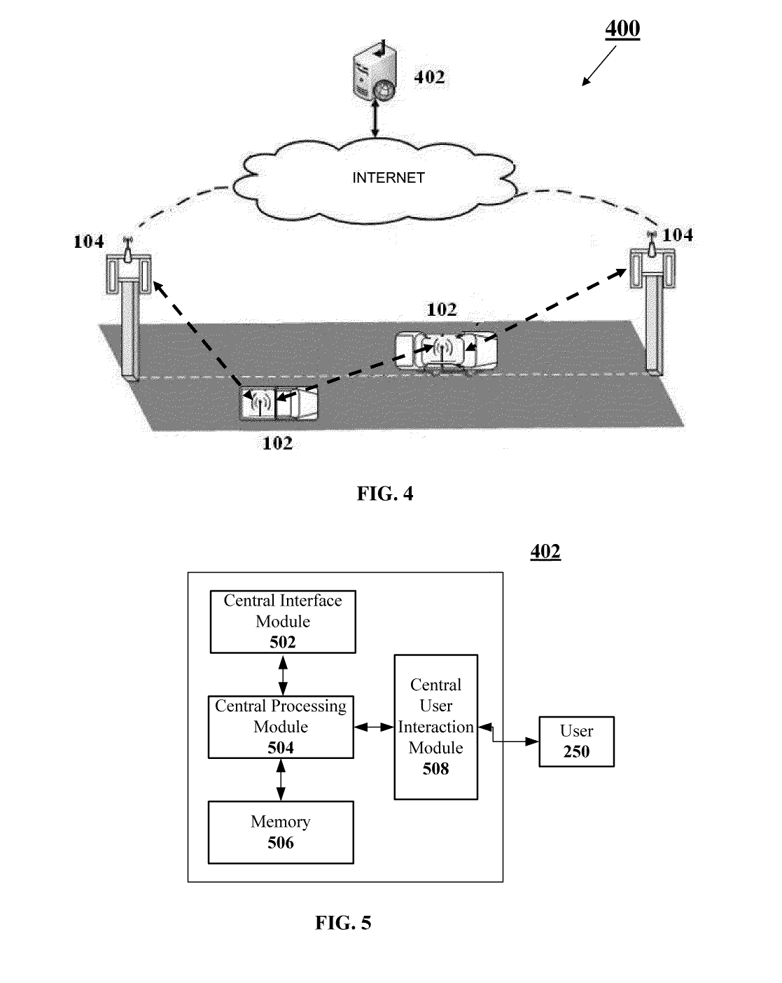

Referring to FIG. 4, in another embodiment, illustrated is a system 400 for traffic incident reporting. The system 400 comprises: a plurality of mobile communication units (such as the mobile communication units 102), a plurality of fixed communication units (such as the fixed communication units 104), and a central unit 402 operably communicating with each other over a wireless network. Each of the plurality of mobile communication units is capable of: gathering data of an associated vehicle; transmitting data on the associated vehicle to other mobile communication units 102, the plurality of fixed communication units 104 and the central unit 402; and receiving data from other mobile communication units 102 and the plurality of fixed communication units 104 on other associated vehicles.

Each of the fixed communication unit 104 is capable of: receiving data of the associated vehicles from the plurality of mobile communication units 102 and other fixed communication units 104; and transmitting data of the associated vehicles to the plurality of mobile communication units 102, other fixed communication units 104, and the central unit 402. The central unit 402 is capable of: receiving data on associated vehicles from the plurality of mobile communication units 102 and the plurality of fixed communication units 104; processing and analyzing data on associated vehicles in a pre-defined area to generate a traffic incident report; storing data of the associated vehicles and the traffic incident report; and providing the traffic incident report to a user (such as a user 250).

Referring to FIG. 5, the central unit 402 comprises a central interface module 502. The central interface module 502 is capable of: receiving data of associated vehicles from the plurality of mobile communication units 102 and the plurality of fixed communication units 104. The central interface module 402 includes a transceiver (a transmitter and receiver combination device) capable of wirelessly receiving data on other associated vehicles, and capable of wirelessly transmitting data on associated vehicle to other units.

The central unit 402 further comprises a central processing module 504 in operative communication with the central interface module 502. The central processing module 504 receives data of the associated vehicle from the central interface module 502. The central processing module is capable of processing and analyzing data of the associated vehicles in a pre-defined area to generate a traffic incident report. The central processing module 504 may be in form of a single hardware component. Alternatively, the central processing module 504 may be a combination of multiple software, firmware and hardware components. The central processing module 504 has appropriate software such that the central processing module 504 can interpret and process V2X and other similar technologies.

The central unit 402 further comprises a memory 506 in operative communication with the central processing module 504. The memory 506 is capable of storing storing received data of the associated vehicles and the traffic incident report. The memory 506 may be in form of a random access memory or other type of dynamic storage device, sufficient to hold the necessary programming and data structures located on the central processing module 504. Alternatively, the memory 506 may take the form of a memory card, memory stick, compact flash, and the like. Overall, the memory 506 serves as a remote database storage, server storage or a cloud storage.

The central unit 506 further comprises a central user interaction module 508 in operative communication with the central processing module 506. The central user interaction module 508 is capable of providing traffic incident report to the user 250. The traffic incident report may be accessed by the user 250 at the site of the central unit 506. In this case, the central user interaction module 508 may be in form of a unit having a Bluetooth interface, USB interface and the like. Alternatively, the central user interaction module 506 wirelessly transmits the traffic incident report to a personal communication device of the user 250. The personal communication device may be a mobile communication device (for example, cell phones, tablets, laptops and the like) or a desktop of the user 250.

The mobile communication units of system 400 of FIG. 4 are similar to the mobile communication units 102 as described with reference to system 100 of FIG. 1. The sensor 202 and the mobile interface module 204 are essential components of the mobile communication unit 102. The mobile processing module 206 may be optional in this embodiment as the processing and analysis of the data of the associated vehicles is carried out by the central unit 402. Similarly, the memory 208 is an optional component for the mobile communication unit 102, and the system 400 has the capability of storing the data on associated vehicles and traffic incident report both locally in the memory 208 or in remotely in the memory 506 of the central unit 402. Also, the fixed communication units are similar to the fixed communication units 104 as described with reference to system 100 of FIG. 1. Similarly, other than the fixed interface module 302, the remaining components of the fixed communication units 104 are optional components.

The central unit 402 is further capable of transmitting the traffic incident report to the plurality of mobile communication units 102 and the plurality of fixed communication units 104. With this capability, the system 400 provides the user 250 with the facility of accessing the traffic incident report at either the central user interaction module 508 or the mobile user interaction module 210 or the fixed user interaction module 308.

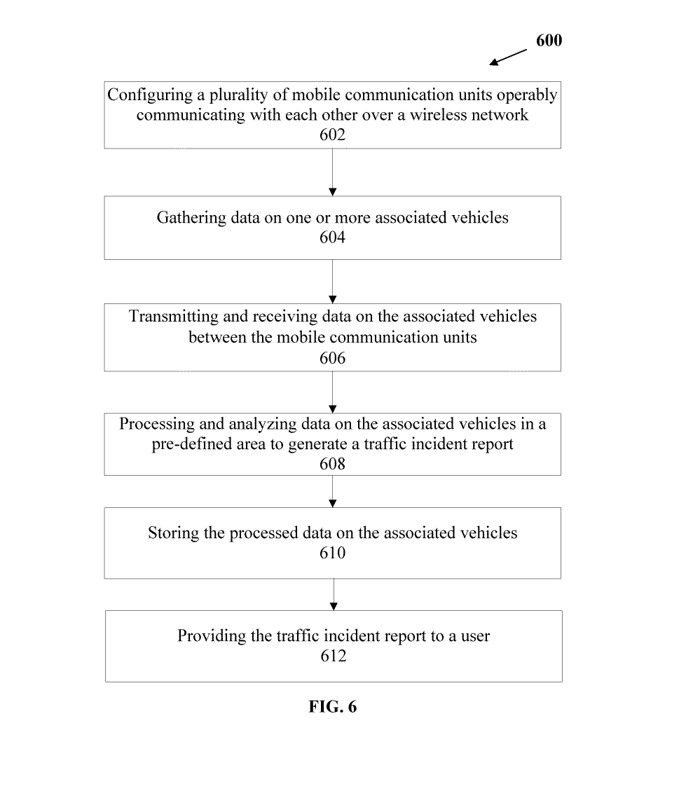

Referring to FIG. 6, in one embodiment, illustrated is a method 600 for traffic incident reporting (employing a system of the present invention such as the system 100 of FIG. 1). The method comprises: configuring a plurality of mobile communication units operably communicating with each other over a wireless network, at step 602; gathering data on one or more associated vehicles, at step 604; transmitting and receiving data on the associated vehicles between the mobile communication units, at step 606; processing and analyzing data on the associated vehicles in a pre-defined area to generate a traffic incident report, at step 608; storing the processed data on associated vehicles and the traffic incident report, at step 610; and providing the traffic incident report to a user, at step 612.

The method 600 further comprises configuring a plurality of fixed communication units operably communicating with each other and the plurality of mobile communication units over the wireless network. Due to presence of fixed communication units, now the fixed communication units can: process and analyze data on associated vehicles to generate a traffic incident report; store the processed data on associated vehicles and the traffic incident report; and provide the traffic incident report to the user

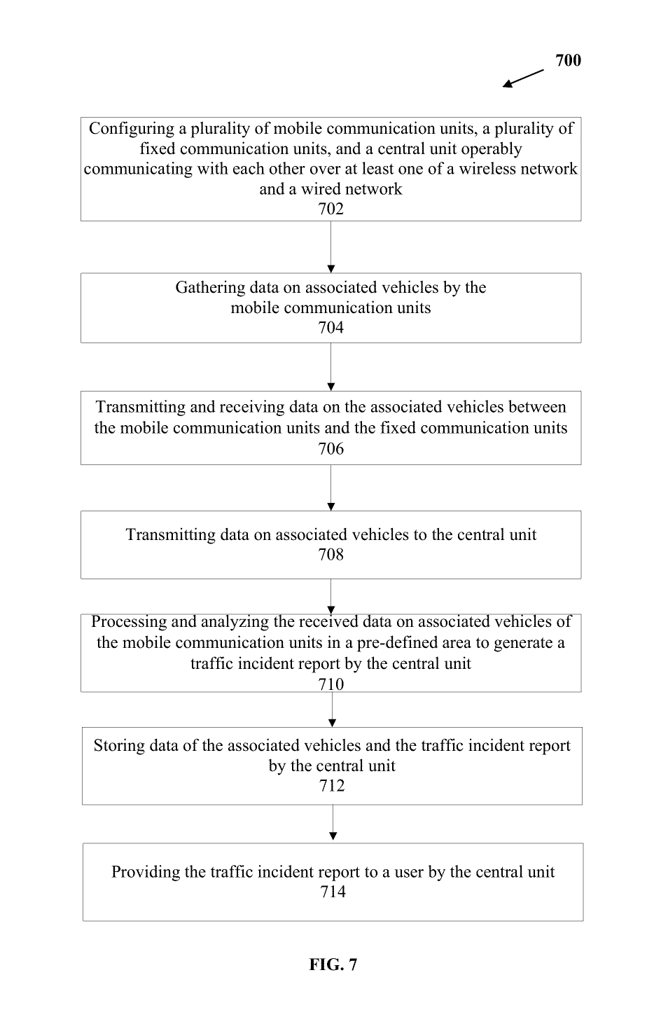

Referring to FIG. 7, in another embodiment, illustrated is a method 700 for traffic incident reporting (employing a system of the present invention such as the system 400 of FIG. 4). The method 700 comprises: configuring a plurality of mobile communication units, a plurality of fixed communication units and a central unit operably communicating with each other over at least one of a wireless network and a wired network, at step 702; gathering data on associated vehicles by the mobile communication units, at step 704; transmitting and receiving data on the associated vehicles between the mobile communication units and the fixed communication units, at step 706; transmitting data on associated vehicles to the central unit, at step 708; processing and analyzing the received data on associated vehicles of the mobile communication units in a pre-defined area to generate a traffic incident report by the central unit, at step 710; storing data of the associated vehicles and the traffic incident report by the central unit, at step 712; and providing the traffic incident report to a user by the central unit, at step 714.

As described above, the system and method the present invention is implemented using the V2X technology and other technologies that allow vehicles to communicate to each other and to road infrastructure wirelessly. As per the current trends in the related standards, each vehicle will be wirelessly and periodically transmitting useful information that include its movement (i.e. location, speed, heading, etc), its exterior lights status, its type and size, and the like. In the same time, each vehicle will be able to receive information transmitted by other vehicles in the surrounding, as illustrated in FIG. 8. When a traffic incident occurs on the road e.g. a traffic accident, often confusions on whom is the faulty part or parts. The present invention solves this issue, by using V2X and other similar technologies.

Referring to FIG. 9, when an incident occurs, the recorded information can be used not only to understand what caused the incident, but also to assess who is the faulty party in that incident. The same recorded data can be used in case an incident occurs, but it could be also used for other businesses like reinforcing the assessment of the driver behavior which has been so far done based on recorded data that includes only the own vehicle but not the other vehicles in the surrounding. As explained with reference to system 100 of FIG. 1 and system 400 of FIG. 4, the status and movement information of a vehicle and its neighbors (i.e. other vehicles and road users in the surrounding) are mainly recorded locally, but the option of remote recording (thinking about cloud computing) is also included.

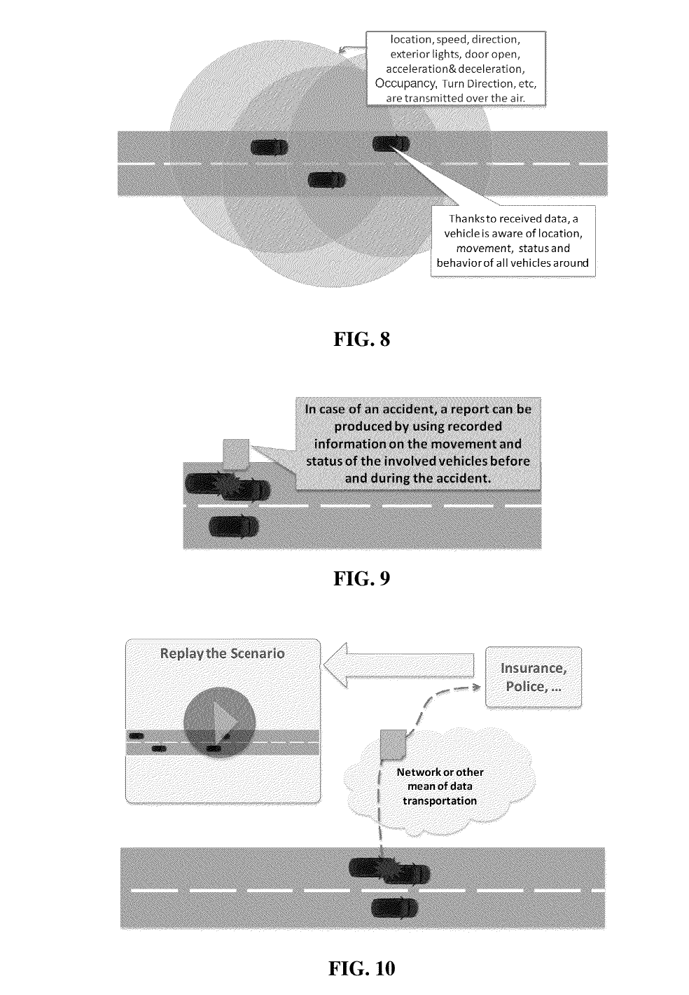

Referring to FIG. 10, illustrated is a non-limiting example of utilization of recorded information when an incident (herein an accident) happens. When the incident occurs, the recorded information is transmitted through the wireless network (for example, the internet) to the appropriate authorities (for example, traffic police and related insurance companies). The information is used to generate trace logs that can be used by a visualization tool that can visualize the vehicles driving around the accident location in the last few minutes before the accident.

Also, techniques, devices, subsystems and methods described and illustrated in the various embodiments as discrete or separate may be combined or integrated with other systems, modules, techniques, or methods without departing from the scope of the present technology. Other items shown or discussed as directly coupled or communicating with each other may be coupled through some interface or device, such that the items may no longer be considered directly coupled to each other but may still be indirectly coupled and in communication, whether electrically, mechanically, or otherwise, with one another. Other examples of changes, substitutions, and alterations ascertainable by one skilled in the art, upon studying the exemplary embodiments disclosed herein, may be made without departing from the spirit and scope of the present technology.

It should be noted that reference throughout this specification to features, advantages, or similar language does not imply that all of the features and advantages should be or are in any single embodiment. Rather, language referring to the features and advantages may be understood to mean that a specific feature, advantage, or characteristic described in connection with an embodiment may be included in at least one embodiment of the present technology. Thus, discussions of the features and advantages, and similar language, throughout this specification may, but do not necessarily, refer to the same embodiment.

What is claimed is:

1. A system for traffic incident reporting, comprising:
a plurality of mobile communication units operably communicating with each other over a wireless network, wherein each of the plurality of mobile communication units comprises
a sensor capable of gathering data of an associated vehicle,
a mobile interface module in operative communication with the sensor and other mobile communication units, the mobile interface module capable of
receiving data of the associated vehicle from the sensor,
transmitting data of the associated vehicle to other mobile communication units, and
receiving data of other associated vehicles from other mobile communication units,
a mobile processing module in operative communication with the sensor and the mobile interface module, the mobile processing module capable of processing and analyzing data of the associated vehicles in a pre-defined area to generate a traffic incident report,
a memory in operative communication with the mobile processing module, the memory capable of storing the processed data of associated vehicles and the traffic incident report, and
a mobile user interaction module in operative communication with the mobile processing unit, the user interaction module capable of providing the traffic incident report to a user.

2. The system of claim 1, data of the associated vehicles comprise at least one of
a location data of the vehicles,
a speed data of the vehicles,
a type and size data of the vehicles,
a driver data of the vehicles, and
a passenger data of the vehicles.

3. The system of claim 1, wherein the mobile communication unit is at least one of
a unit installed in the associated vehicle, and
a unit installed in a personal communication device of the user.

4. The system of claim 1, wherein the mobile interface module includes a transceiver.

5. The system of claim 1, wherein the plurality mobile communication units employ vehicle to vehicle and vehicle to infrastructure wireless technology.

6. The system of claim 1, wherein the mobile user interaction module wirelessly transmits the traffic incident report to a personal communication device of the user.

7. The system of claim 1, further comprising a plurality of fixed communication units operably communicating with the plurality of mobile communication units and the other fixed communication units over the wireless network, wherein each of the plurality of fixed communication units comprises
a fixed interface module capable of
receiving data of associated vehicles of the mobile communication units, and
transmitting data of associated vehicles to other fixed communication units and the mobile communication units,
a fixed processing module in operative communication with the fixed interface module, the fixed processing module capable of processing and analyzing the received data of associated vehicles of the mobile communication units in a pre-defined area to generate the traffic incident report,
a memory in operative communication with the fixed processing module, the memory capable of storing the received data of the associated vehicles, and the traffic incident report, and
a fixed user interaction module in operative communication with the fixed processing module, the fixed user interaction module capable of providing the traffic incident report to the user.

8. The system of claim 7, wherein the mobile interface module includes a transceiver.

9. The system of claim 7, wherein the plurality of fixed communication units employ vehicle to vehicle and vehicle to infrastructure communication technology.

10. The system of claim 7, wherein the fixed user interaction module wirelessly transmits the traffic incident report to a personal communication device of the user.

11. A system for traffic incident reporting, comprising:
a plurality of mobile communication units, a plurality of fixed communication units and a central unit operably communicating with each other over a wireless network;
wherein each of the plurality of mobile communication units is capable of
gathering data of an associated vehicle,
transmitting data of the associated vehicle to other mobile communication units, the plurality of fixed communication units and the central unit, and
receiving data of other associated vehicles from other mobile communication units;
wherein each of the fixed communication unit is capable of
receiving data of the associated vehicles from the plurality of mobile communication units and other fixed communication units, and
transmitting data of the associated vehicles to the plurality of mobile communication units, other fixed communication units, and the central unit;
wherein the central unit is capable of
receiving data of the associated vehicles from the plurality of mobile communication units and the plurality of fixed communication units,
processing and analyzing the received data of the associated vehicles of the mobile communication units in a pre-defined area to generate a traffic incident report,
storing data of the associated vehicles and the traffic incident report, and
providing the traffic incident report to a user.

12. The system of claim 11, data on associated vehicles comprises at least one of
a location data of the vehicles,
a speed data of the vehicles,
a lighting status of the vehicles,
a driver data of the vehicles, and
a passenger data of the vehicles.

13. The system of claim 11, wherein the mobile communication unit is at least one of
a unit installed in the associated vehicle, and
a unit installed in a personal communication device of a user travelling in the associated vehicle.

14. The system of claim 11, wherein the plurality of mobile communication units and the plurality of fixed communication units employ V2X technology.

15. The system of claim 11, wherein the central unit comprises
a central interface module capable of receiving data of associated vehicles from the plurality of mobile communication units and the plurality of fixed communication units,
a central processing module capable of processing and analyzing the received data of the associated vehicles of the mobile communication units in a pre-defined area to generate the traffic incident report,
a memory capable of storing data of the associated vehicles and the traffic incident report, and
a central user interaction module providing the traffic incident report to the user.

16. The system of claim 11, wherein the central unit is further capable of transmitting the traffic incident report to the plurality of mobile communication units and the plurality of fixed communication units.

17. A method for traffic incident reporting, comprising:
configuring a plurality of mobile communication units operably communicating with each other over a wireless network;
gathering data on one or more associated vehicles;
transmitting and receiving data on the associated vehicles between the mobile communication units;
processing and analyzing data on the associated vehicles in a pre-defined area to generate a traffic incident report;
storing the processed data on associated vehicles and the traffic incident report; and
providing the traffic incident report to a user.

18. The method of claim 17, wherein the method further comprises
configuring a plurality of fixed communication units operably communicating with each other and the plurality of mobile communication units over the wireless network;
processing and analyzing data on the associated vehicles by the fixed communication units in a pre-defined area to generate a traffic incident report;
storing the processed data on associated vehicles and the traffic incident report in the fixed communication units;
providing the traffic incident report to the user by the fixed communication units.

19. The method claim 17, wherein the plurality of mobile communication units and the plurality of fixed communication units employ V2X technology.

20. A method for traffic incident reporting, comprising:
configuring a plurality of mobile communication units, a plurality of fixed communication units and a central unit operably communicating with each other over at least one of a wireless network and a wireless network;
gathering data on associated vehicles by the mobile communication units;
transmitting and receiving data on the associated vehicles between the mobile communication units and the fixed communication units;
transmitting data on associated vehicles to the central unit;
processing and analyzing the received data on associated vehicles of the mobile communication units in a pre-defined area to generate a traffic incident report by the central unit;
storing data of the associated vehicles and the traffic incident report by the central unit; and
providing the traffic incident report to a user by the central unit.

21. A system for traffic incident reporting comprising:
a plurality of vehicles and infrastructure units employing a vehicle to vehicle and vehicle to infrastructure communication technology capable of sharing real time and historical information of one or more vehicles involved in the traffic incident and other vehicles in a predefined area of the traffic incident.

22. A system for traffic law violation detection and reporting, comprising:
a plurality of vehicles and infrastructure units employing a vehicle to vehicle and vehicle to infrastructure communication technology capable of sharing real time and historical information of one or more vehicles involved in the traffic law violation and other vehicles in a predefined area of the traffic law violation.
